(19) United States
(12) Patent Application Publication
(10) Pub. No.: US 2012/0008056 A1
(43) Pub. Date: Jan. 12, 2012

(54) THREE-DIMENSIONAL (3D) OPTICAL DEVICE, METHOD AND SYSTEM

(76) Inventor: XIAODA GONG, Shenzhen (CN)

(21) Appl. No.: 12/906,055

(22) Filed: Oct. 15, 2010

(30) Foreign Application Priority Data
Jul. 9, 2010 (CN) 201010229907.7

(51) Int. Cl. G02B 27/22; G02F 1/1335

(52) U.S. Cl. 349/15; 359/463

(57) ABSTRACT

An optical device is provided for three-dimensional (3D) display. The optical device includes a first substrate and a second substrate arranged corresponding to the first substrate. The optical device also includes an electrowetting component. The electrowetting component is placed between the first substrate and the second substrate. Further, the electrowetting component includes a first electrode and a second electrode arranged corresponding to the first electrode. The electrowetting component also includes a first fluid, a second fluid, and a plurality of fluid chambers containing the first fluid and the second fluid. The second fluid is undissolvable in or unmixable with the first fluid; and the plurality of fluid chambers are arranged between the first electrode and the second electrode. Further, the plurality of fluid chambers form a plurality of liquid cylindrical lenses when at least one voltage difference is generated between the first electrode and the second electrode.

### CROSS-REFERENCES TO RELATED APPLICATIONS

This application claims the priority of Chinese patent application number 201010229907.7, filed on Jul. 9, 2010, the entire contents of which are incorporated herein by reference.

### FIELD OF THE INVENTION

The present invention generally relates to three-dimensional (3D) display technologies and, more particularly, to the methods and systems for generating 3D display using optical devices based on liquid materials.

### BACKGROUND

A person's left eye and right eye are in different horizontal positions separated by a small distance, resulting in two slightly different retinal images viewed by the person's left eye and right eye. The disparity between the different retinal images, observations of scenes from the left eye and the right eye, is called parallax. The human brain processes the different left image and right image with the parallax to form a three-dimensional (3D) image.

Existing autostereoscopic display systems, which do not require viewers to wear 3D glasses in order to view 3D images, are based on various types of 3D display technologies, such as cylindrical lens screen display, slit grating 3D display, and holographic display. Among them, cylindrical lens screen based 3D display technology becomes popular due to its good manufacturability.

FIG. 1 shows a conventional 3D display device. As shown in FIG. 1, 3D display device 1 uses a solid cylindrical lens grating to achieve 3D display. 3D display device 1 includes a liquid crystal display (LCD) panel 11 and a solid cylindrical lens grating 13 closely coupled with LCD panel 11.

LCD panel 11 includes a number of pixels in a two-dimensional matrix arrangement, and each pixel consists of three sub-pixels (i.e., RGB sub-pixels). Cylindrical lens grating 13 includes a number of cylindrical lenses arranged in parallel to form a solid cylindrical lens grating. A 3D image displayed on LCD panel 11 can be separated into two different images by cylindrical lens grating 13 such that the two different images can be viewed by a viewer's left eye and right eye respectively.

However, in such conventional 3D display device 1, cylindrical lens grating 13 is a solid component, and the coupling between cylindrical lens grating 13 and LCD panel 11 is also fixed. Although cylindrical lens grating 13 can achieve 3D display, cylindrical lens grating 13 can only display 3D images and is not compatible with two-dimensional (2D) display. To a viewer, a long-term use of cylindrical lens grating 13 to watch 3D display may result in vision fatigue and a negative impact on the health of the viewer's eyes.

FIG. 2 shows a 3D display device 2, which uses liquid crystal as lenses to overcome these problems. As shown in FIG. 2, 3D display device 2 includes a backlight module 21, an LCD panel 23, and a liquid crystal lens 25. Liquid crystal lens 25, LCD panel 23, and backlight module 21 are coupled together in sequence such that LCD panel 23 is positioned between backlight module 21 and liquid crystal lens 25.

Backlight module 21 is closely coupled to LCD panel 23 to provide backlight to LCD panel 23. When LCD panel 23 displays a 3D image, lights from LCD panel 23 of the 3D image are guided by liquid crystal lens 25 into two separate images with a parallax for a viewer's left eye and right eye separately.

FIG. 3 shows a cross-section view of liquid crystal lens 25 of 3D display device 2. As shown in FIG. 3, liquid crystal lens 25 includes a first substrate 251 and a second substrate 255, arranged in parallel with a certain distance. Liquid crystal lens 25 also includes a liquid crystal layer 253 placed between first substrate 251 and second substrate 255. A first electrode 252 is placed on a surface of first substrate 251 facing liquid crystal layer 253, and a plurality of second electrodes 254 are placed on a surface of second substrate 255 facing liquid crystal layer 253. The plurality of second electrodes 254 are arranged in parallel with a fixed interval.

As liquid crystal layer 253 is in the space between first electrode 252 and second electrodes 254, liquid crystal molecules of liquid crystal layer 253 may respond to changes of an electric field between first electrode 252 and second electrodes 254, such as changes in electric field intensity and distribution.

When different voltages are applied to first electrode 252 and second electrodes 254, a vertical electric field is formed between first electrode 252 and a second electrode 254. Along the horizontal direction, the intensity of the electric filed is the strongest at the center of the second electrode 254, and decreases from the center of second electrode 254. Because the liquid crystal molecules of liquid crystal layer 253 are of positive dielectric anisotropy, the angle of rotation of the liquid crystal molecules in the electric field also decreases away from the center of second electrode 254 in the horizontal direction.

That is, at the center of second electrode 254, liquid crystal molecules may be in a vertical position (i.e., a rotation of 90 degrees), and may gradually tilt towards a horizontal position in the direction away from the center of second electrode 254. Thus, based on light refraction characteristic of the liquid crystal, its optical path or light path has the shortest distance at the center of second electrode 254, and increases in the direction away from the center of second electrode 254, as shown in FIG. 4. Therefore, liquid crystal layer 253 has the effect of an optical lens and thus realizes liquid crystal lens 25. Liquid crystal lens 25 can thus be used to separate images of a 3D image to achieve 3D display. Further, if no voltages are applied to first electrode 252 and second electrodes 254, no lens effect will be realized and 2D images can be displayed. Thus, 2D display and 3D display can also be switched freely.

However, in the liquid crystal lens approach, for a display with a large display area, the edge of a lens formed by a second electrode 254 is virtually unaffected by the electric field, making it difficult to control the orientation of liquid crystal molecules in the edge region. This may lead to lens deformation and discontinuity of the liquid crystal lens, all of which may impact display quality.

Further, because first and second electrodes 252 and 254 cover most regions of liquid crystal lens 25, steep side electric fields, instead of a flat electric field may appear at center and edge of a liquid crystal lens. To form effective smooth parabolic-shaped liquid crystal lens, the distance between first electrode 252 and second electrodes 254 may need to be increased, which may also result in a bulky and heavy liquid crystal lens grating 25 and a large amount of liquid crystal to be required. Finally, because liquid crystal layer 253 may have different refractive index from glass substrates, switching between 2D display and 3D display may not be uniform due to variations of the thickness of liquid crystal layer 253.

The disclosed methods and systems are directed to solve one or more problems set forth above and other problems.

### BRIEF SUMMARY OF THE DISCLOSURE

One aspect of the present disclosure includes an optical device for three-dimensional (3D) display. The optical device includes a first substrate and a second substrate arranged corresponding to the first substrate. The optical device also includes an electrowetting component. The electrowetting component is placed between the first substrate and the second substrate. Further, the electrowetting component includes a first electrode and a second electrode arranged corresponding to the first electrode. The electrowetting component also includes a first fluid, a second fluid, and a plurality of fluid chambers containing the first fluid and the second fluid. The second fluid is undissolvable in or unmixable with the first fluid; and the plurality of fluid chambers are arranged between the first electrode and the second electrode. Further, the plurality of fluid chambers form a plurality of liquid cylindrical lenses when at least one voltage difference is generated between the first electrode and the second electrode.

Another aspect of the present disclosure includes a 3D display device. The 3D display device includes a display module, an optical device, and a driving module. The display module is configured to display images; the optical device is coupled to the display module to guide lights from the images displayed by the display module; and the driving module is configured to control optical device to switch between a 2D display and a 3D display. Further, the optical device includes a first substrate and a second substrate arranged corresponding to the first substrate. The optical device also includes an electrowetting component. The electrowetting component is placed between the first substrate and the second substrate. Further, the electrowetting component includes a first electrode and a second electrode arranged corresponding to the first electrode. The electrowetting component also includes a first fluid, a second fluid, and a plurality of fluid chambers containing the first fluid and the second fluid. The second fluid is undissolvable in or unmixable with the first fluid; and the plurality of fluid chambers are arranged between the first electrode and the second electrode. Further, the plurality of fluid chambers form a plurality of liquid cylindrical lenses when at least one voltage difference is generated between the first electrode and the second electrode.

Other aspects of the present disclosure can be understood by those skilled in the art in light of the description, the claims, and the drawings of the present disclosure.

### BRIEF DESCRIPTION OF THE DRAWINGS

FIG. 1 illustrates a conventional 3D display device;

FIG. 2 illustrates a conventional 3D display device;

FIG. 3 illustrates a cross-section view of a liquid crystal lens;

FIG. 4 illustrates an optical path diagram;

FIG. 5 illustrates an exemplary 3D display device consistent with the disclosed embodiments;

FIG. 6 illustrates exemplary displayed images consistent with the disclosed embodiments;

FIG. 7 illustrates an exemplary optical device consistent with the disclosed embodiments;

FIG. 8 illustrates certain details of an exemplary optical device consistent with the disclosed embodiments;

FIG. 9 illustrates certain details of an exemplary optical device consistent with the disclosed embodiments;

FIG. 10 illustrates certain details of an exemplary optical device consistent with the disclosed embodiments;

FIG. 11 illustrates another exemplary optical device consistent with the disclosed embodiments;

FIG. 12 illustrates another exemplary optical device consistent with the disclosed embodiments; and

FIG. 13 illustrates exemplary operation of an exemplary optical device consistent with the disclosed embodiments.

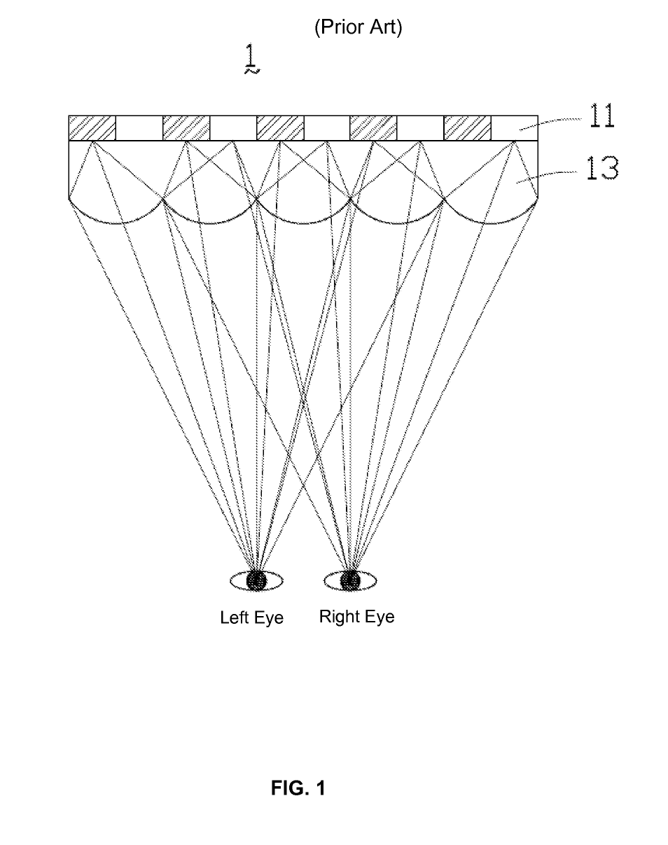

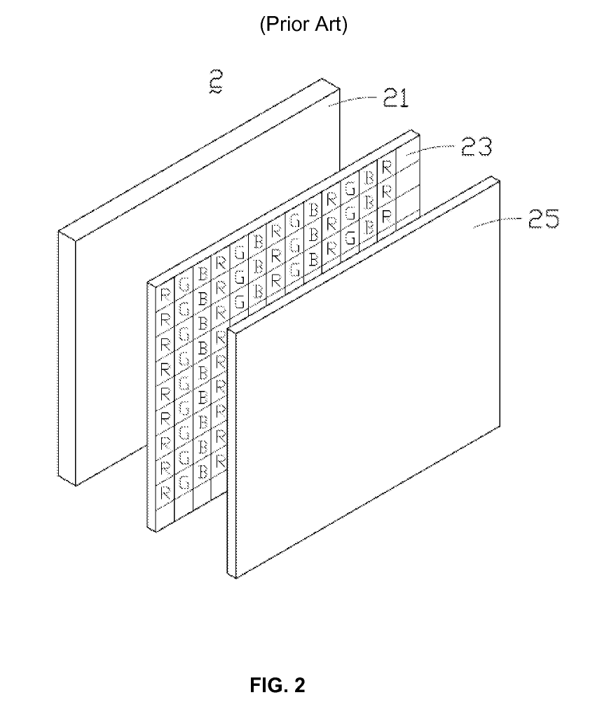

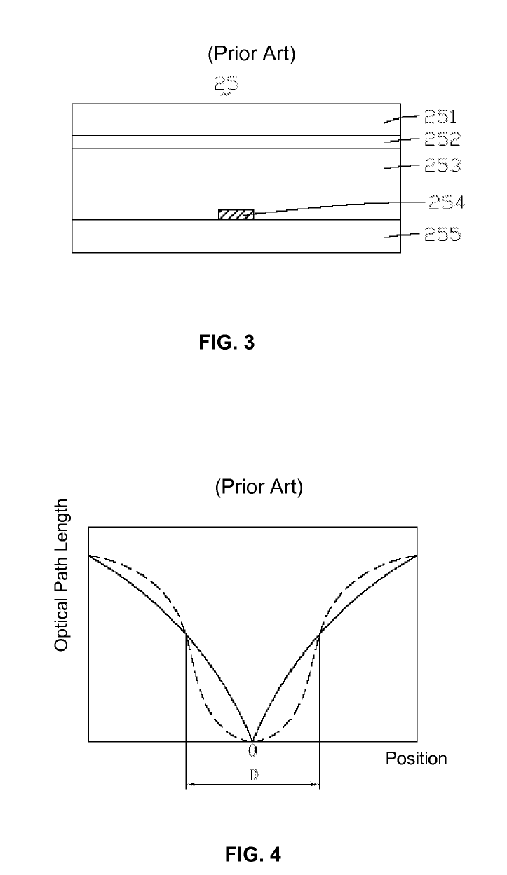

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

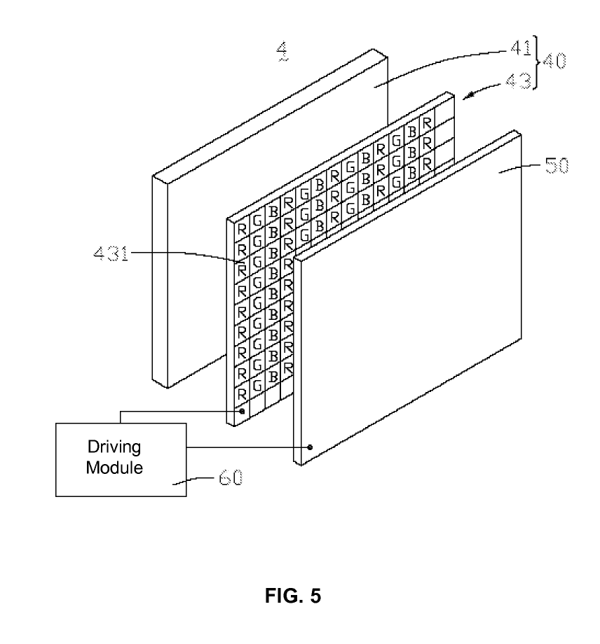

FIG. 5 illustrates an exemplary three-dimensional (3D) display device consistent with the disclosed embodiments. As shown in FIG. 5, a 3D display device 4 includes a display module 40, an optical device 50, and a driving module 60. 3D display device 4 may include any appropriate device that is capable of processing and displaying 3D images, such as a computer, a television set, a smart phone, or a consumer electronic device. Other components may also be included in 3D display device 4.

Optical device 50 is closely coupled to display module 40 to process lights from display module 40. Driving module 60 may be coupled to display module 40 and optical device 50 to provide any appropriate driving circuitry to operate display module 40 and optical device 50. Driving module 60 may also include any appropriate processing module such as a graphic processing unit (GPU), a general-purpose microprocessor, a digital signal processor (DSP) or a microcontroller, and an application specific integrated circuit (ASIC), etc. The processing module may also execute sequences of computer program instructions to perform various processes associated with driving module 60.

Driving module 60 may provide video signals to display module 40 during operation. When driving module 60 provides two-dimensional (2D) video signals to display module 40, display module 40 displays 2D images corresponding to video frames of the 2D video signals; and when driving module 60 provides 3D video signals to display module 40, display module 40 displays 3D images corresponding to 3D video frames of the 3D video signals. Lights from the 2D images or 3D images are guided by optical device 50 accordingly. A 3D image may include a first image to be viewed by a viewer's left eye and a second image to be viewed by the viewer's right eye.

Driving module 60 also provides driving signals to control optical device 50 to guide the lights from display module 40. For example, driving module 60 may provide driving signals to optical device 50 to guide lights from 2D images to directly pass through, and to guide lights from a 3D image into two separate images, a left image and a right image, respectively for a viewer's left eye and right eye for the viewer to perceive the 3D image.

Display module 40 may include a backlight module 41 and a liquid crystal display (LCD) panel 43. Backlight 41 is closely coupled to LCD panel 43 to provide backlights to LCD panel 43 to display images. LCD panel 43 may include a plurality of pixels arranged in a two-dimensional matrix, and each pixel may include multiple sub-pixels. For example, each pixel includes three sub-pixels as sub-pixel ‘IR’, sub-pixel ‘G’, and sub-pixel ‘B’, i.e., RGB sub-pixels. As used herein, a pixel 431 may refer to a pixel unit which is either a pixel or a sub-pixel as applicable to particular applications.

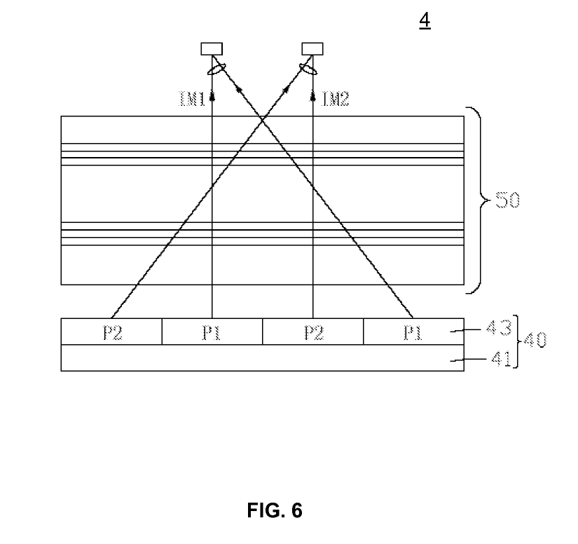

FIG. 6 shows a 3D image displayed with pixels 431 (e.g., P1 and P2) of display module 40. As shown in FIG. 6, a 3D image includes two interleaved images and each image is displayed using multiple pixels 431. Pixels 431 for displaying the first interleaved image are marked as “P1” and pixels 431 for displaying the second interleaved image are marked as “P2”. Lights from the two images, i.e., from “P1s” and “P2s”, are guided by optical device 50 into two viewing zones thereby forming two separate images: a first image IM1 from all “P1s” and a second image IM2 from all “P2s”. First image IM1 and second image IM2 can then be viewed by a viewer's left eye and right eye separately.

Although display module 40 is based on LCD as shown, display module 40 may include any appropriate device for displaying images, such as a plasma display panel (PDP) display, a cathode ray tube (CRT) display, a field emission display (FED), an organic light emitting diode (OLED) display, and other types of displays.

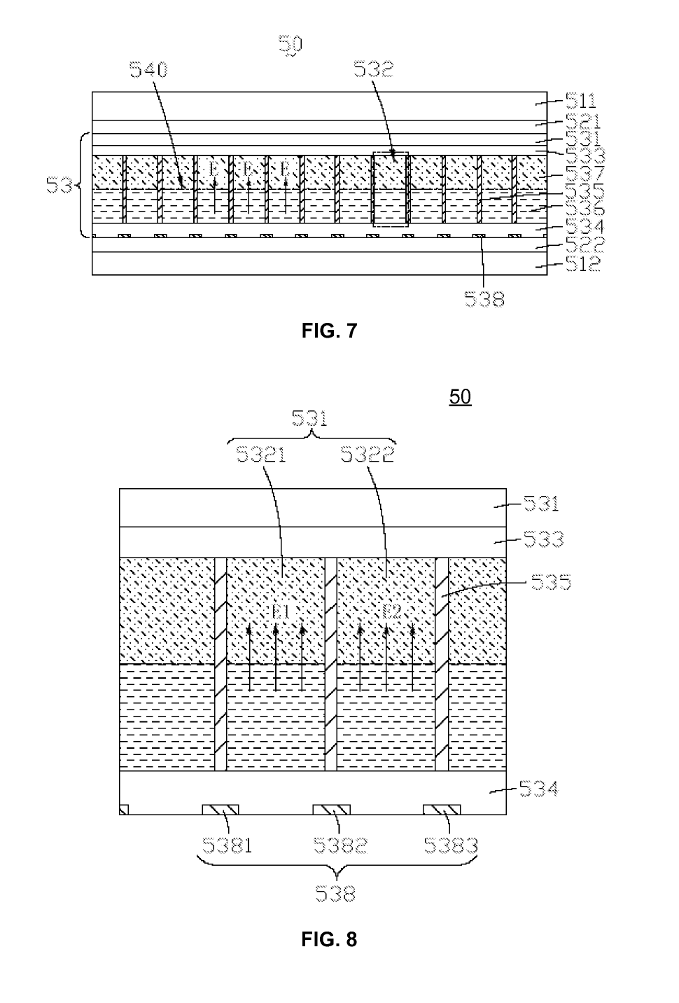

FIG. 7 shows a cross-section view of an exemplary optical device consistent with the disclosed embodiments. An optical device 50 may be an electrowetting lens module. An electrowetting lens is based on the electrowetting concept that, by applying a voltage on a fluid to change certain surface tension of the fluid, its volume flows in the direction of minimum surface tension and thus influencing wetting characteristics of the fluid relative to a particular surface.

As shown in FIG. 7, optical device 50 (i.e., electrowetting lens module 50) includes a first transparent substrate 511, a second transparent substrate 512, a first transparent insulation layer 521, a second transparent insulation layer 522, and an electrowetting component 53. Other components may also be included.

First transparent substrate 511 and second transparent substrate 512 may be arranged correspondingly and separated by a certain distance between each other. The space between first transparent substrate 511 and second transparent substrate 512 may then be used to host electrowetting component 53. First transparent insulation layer 521 may be placed or built on a surface of first transparent substrate 511 facing electrowetting component 53; and second transparent insulation layer 522 may be placed or built on a surface of second transparent substrate 512 facing electrowetting component 53. First transparent insulation layer 521 and second transparent insulation layer 522 may both be in a smooth plane-shape and may be formed by vacuum coating mechanisms on corresponding surfaces of first transparent substrate 511 and second transparent substrate 512, respectively.

Electrowetting component 53 includes a first electrode 531, a plurality of fluid chambers 532, a first insulation layer 533, and a second insulation layer 534 arranged corresponding to first insulation layer 533, a plurality of hydrophobic insulation baffles 535 arranged in parallel at a predetermined interval, a first fluid 536, a second fluid 537, and a second electrode 538. Certain components may be removed and certain other components may be added.

First electrode 531 may be a rectangular flat-surface conductive layer placed between first transparent insulation layer 521 and plurality of fluid chambers 532. Second electrode 538 may include a plurality of strip electrodes evenly spaced in parallel. As used herein, second electrode 538 and second electrodes 538 may be interchangeable to refer an overall second electrode, a single second electrode, or a plurality of second electrodes. Second electrodes 538 may be placed between second transparent insulation layer 522 and plurality of fluid chambers 532. Thus plurality of fluid chambers 532 are placed between first electrode 531 and second electrodes 538, and the interval between two neighboring second electrodes 538 correspond to the width of a single fluid chamber 532.

Hydrophobic insulation baffles 535 are arranged perpendicular to first insulation layer 533 and second insulation layer 534. Each fluid chamber 532 is thus a chamber formed by corresponding first insulation layer 533 and second insulation layer 534 and corresponding two hydrophobic insulation baffles 535. Each fluid chamber 532 includes first fluid 536 and second fluid 537. Because first electrode 531 is located between first insulation layer 533 and first transparent insulation layer 521, and second electrodes 538 are located between second insulation layer 534 and second transparent insulation layer 522, an electric filed or fields may be formed between first electrode 531 and second electrodes 538 to control operation of electrowetting component 53.

Further, first fluid 536 may be a nonpolar fluid or insulating fluid, including dissolved or mixed compounds such as silicone oil or paraffin. Second fluid 537 may be a polar fluid or conductive fluid, including dissolved or mixed compounds such as saline solution. The compounds of first fluid 536 and the compounds of second fluid 537 cannot be dissolved in each other or mixed with each other. Further, first fluid 536 and second fluid 537 are divided by an interface 540 (i.e., the fluid surface at the contacting boundary between first fluid 536 and second fluid 537), and first fluid 536 has a larger refractive index than second fluid 537.

FIG. 8 shows certain details of electrowetting component 53 consistent with the disclosed embodiments. As shown in FIG. 8, two neighboring fluid chambers 5321 and 5322 are formed by three neighboring hydrophobic insulation baffles 535, and corresponding first insulation layer 533 and second insulation layer 534. First and second insulation layers 533 and 534 may also made of hydrophobic materials. Three second electrodes 5381, 5382, and 5383 are arranged at intersections between second insulation layer 534 and three neighboring hydrophobic insulation baffles 535. That is, vertically, three second electrodes 5381, 5382, and 5383 are respectively arranged at the ends of three neighboring hydrophobic insulation baffles 535.

Thus, corresponding to first electrode 531, three second electrodes 5381, 5382, and 5383 may form electric fields E1 and E2 in two neighboring fluid chambers 5321 and 5322, respectively. The electric field E1 is controlled by voltage signals applied to first electrode 531 and second electrodes 5381 and 5382; and the electric filed E2 is controlled by voltage signals applied to electrode 531 and second electrodes 5382 and 5383. Under the electric fields E1 and E2, second fluid 537 in fluid chambers 5321 and 5322 may change fluid surface tension and thus may influence fluid wetting characteristics on interface 540.

A time sequence of three continuous time moments T1, T2, and T3 may be used here for illustrative purposes. A time sequence signal may also be sent to optical device 50 from driving module 60 to set particular time sequences for electrowetting component 53. At time T1, electrowetting component 53 may be in a first state S1. In first state S1, no voltages are applied to first electrode 531 and second electrodes 5381, 5382, and 5383. In other words, voltages applied to first electrode 531 and second electrodes 5381, 5382, and 5383 are 0 volts. Thus, no electric field is formed between first electrode 531 and second electrodes 5381, 5382, and 5383, and interface 540 does not change. That is, interface 540 between first fluid 536 and second fluid 537 is parallel to first transparent substrate 511 and second transparent substrate 512. Because different positions in the vertical direction have the same refractive index, electrowetting component 53 does not have the effect of an optical lens. Thus, in first state S1, electrowetting component 53 passes lights directly and is suitable for 2D display.

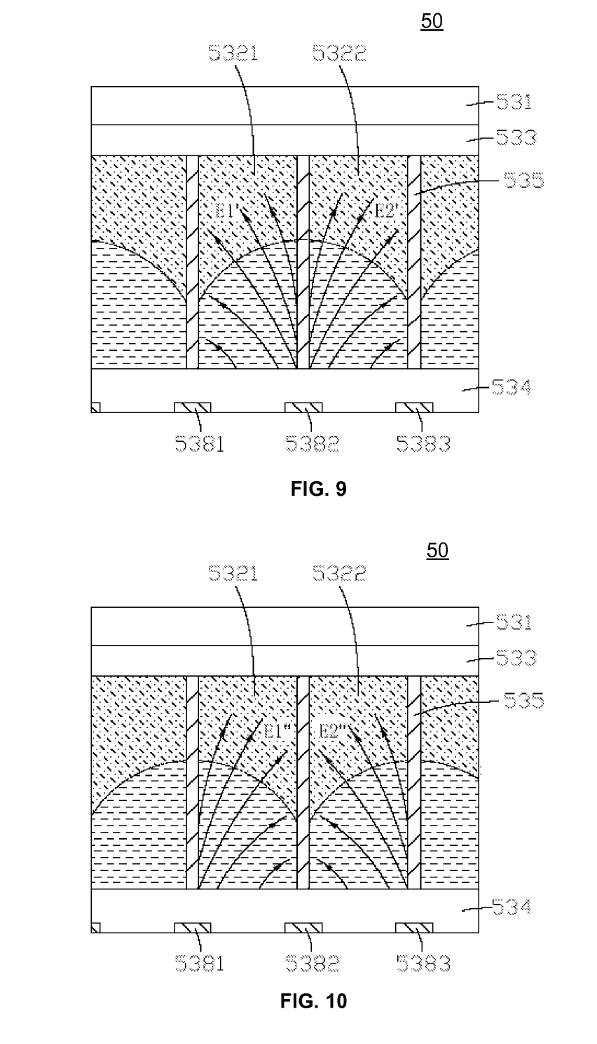

At time T2, as shown in FIG. 9, electrowetting component 53 is in a second state S2. In second state S2, no voltage is applied to first electrode 531. However, a voltage V1 is applied to second electrode 5382, where voltage V1 is greater than zero. A voltage V2 is applied to second electrodes 5381 and 5383, where voltage V2 is less than V1 but greater than zero. Thus, electric fields E1′ and E2′ are created in fluid chambers 5321 and 5322, respectively. Due to the electrowetting effect, interface 540 in each of fluid chambers 5321 and 5322 changes the surface curvature to a semi-parabolic shape. Further, interface 540 in each of fluid chambers 5321 and 5322 are symmetrically centered hydrophobic an insulation baffle 535 such that two neighboring fluid chambers 5321 and 5322 form a liquid cylindrical lens.

Similarly, at time T3, electrowetting component 53 is in a third state S3. As shown in FIG. 10, in third state S3, a voltage V3 is applied to second electrodes 5381 and 5383, where V3 is greater than zero. A voltage V4 is applied to second electrode 5382, where voltage V4 is less than V3 but greater than zero. Thus, electric fields E1″ and E2″ are created in fluid chambers 5321 and 5322, respectively. Due to the electrowetting effect, interface 540 in each of fluid chambers 5321 and 5322 changes the curvature to a semi-parabolic shape, in a reverse direction comparing to interface 540 in second state S2. Each of fluid chambers 5321 and 5322 forms a liquid cylindrical lens with a neighboring fluid chamber.

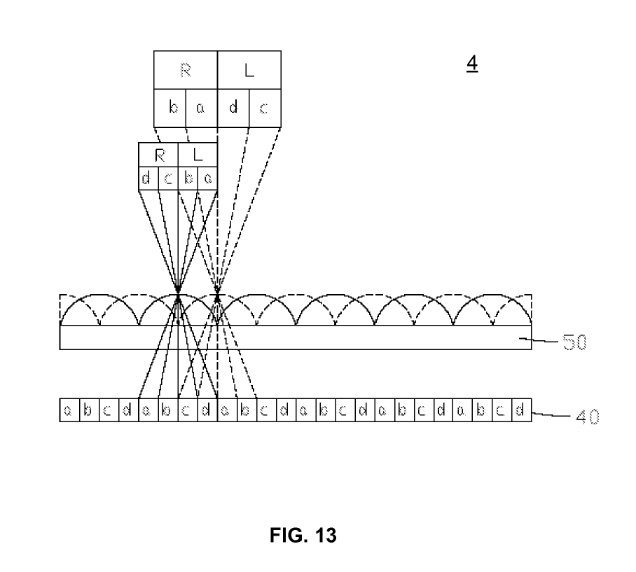

Therefore, at time T2, electrowetting component 53 is in second state S2 and corresponds to a first plurality of liquid cylindrical lenses (or a first liquid crystal lens grating); while at time T3, electrowetting component 53 is in third state S3 and corresponds to a second plurality of liquid cylindrical lenses (or a second liquid crystal lens grating). The second plurality of liquid cylindrical lenses may be treated as a shifted first plurality of liquid cylindrical lenses by an offset. During operation of 3D display device 4, the first plurality of liquid cylindrical lenses and the second plurality of liquid cylindrical lenses may thus be formed alternately to process lights from display module 40. FIG. 13 shows an exemplary operation of 3D display device 4.

When 3D display device 4 displays 2D images, driving module 60 provides 2D video signals to display module 40, and display module 40 displays a 2D image for each video frame. At the same time, driving module 60 sets electrowetting component 53 of optical device 50 into first state S1. Because, in first state S1, electrowetting component 53 does not form liquid cylindrical lens grating, lights from the 2D images displayed on display module 40 passes through optical device 50 without changing directions. Therefore, a viewer's both eyes can see the 2D images for 2D display.

When 3D display device 4 displays 3D images, driving module 60 provides 3D video signals to display module 40, and display module 40 displays a 3D image for each video frame. The 3D image includes a first image to be viewed by the viewer's left eye and a second image to be viewed by the viewer's right eye. At the same time, driving module 60 sends a time sequence signal to optical device 50 to control electrowetting components 53 such that electrowetting component 53 is alternately in second state S2 and third state S3, which is equivalent to electrowetting component 53 alternately being a first liquid cylindrical lens grating and a second liquid cylindrical lens grating.

As shown in FIG. 13, at time T2, electrowetting component 53 becomes a first plurality of cylindrical lens denoted in solid lines. At time T3, electrowetting component 53 becomes a second plurality of cylindrical lens denoted in dotted lines. Also, pixels a, b, c, d represent pixels displaying a 3D image, where pixels a and b represent a first image, and pixels c and d represent a second image. Thus, at time T2, due to the effect of the first plurality of liquid cylindrical lens, the viewer's left eye can see the first image from pixels a and b, while the viewer's right eye can see the second image from pixels c and d.

At time T3, however, because the second plurality of cylindrical lens shifts from the first plurality of cylindrical lens, the viewer's left eye and right eye can see opposite images. For example, at time T3, the viewer's left eye can see the second image from pixels c and d, while the viewer's right eye can see the first image from pixels a and b. When these two states alternate in a certain frequency, because human eyes have vision persistence, the viewer's left eye and right eye can both see a complete left image and right image, respectively, to achieve full-resolution 3D display.

More particularly, lights from 3D images displayed on display module 40 enter optical device 50, and optical device 50 guides the lights into certain directions to form two separate images M1 and M2, with a parallax in between, for the viewer's left eye and right eye, respectively. When the frequency of the time sequence signal reaches a certain level, beyond what human eyes can perceive, optical device 50 alternates between T2 and T3 to guide lights to the viewer's left eye and right eye. If the frequency of the time sequence signal is the same as the frequency at which display module 40 changes left image M1 and right image M2, for example 120 Hz, the viewer cannot tell the difference between displayed images and thus perceive the image as a full-pixel image. When the viewer alternately receives images M1 and M2, due to vision persistence, the viewer can perceive a full-resolution 3D image.

Because electrowetting component 53 can form a uniform electric field for solar fluid in electrowetting component 53, the disclosed systems and methods can substantially increase the controllability of the solar fluid and reduce the deformation of liquid cylindrical lens so as to improve display quality. Further, because electrowetting component 53 can form a smooth parabolic-shaped liquid lens in a small space, the entire liquid cylindrical lens grating can become smaller, thinner, and at lower cost, which further makes 3D display device 4 significantly lighter and less bulky than conventional 3D display devices.

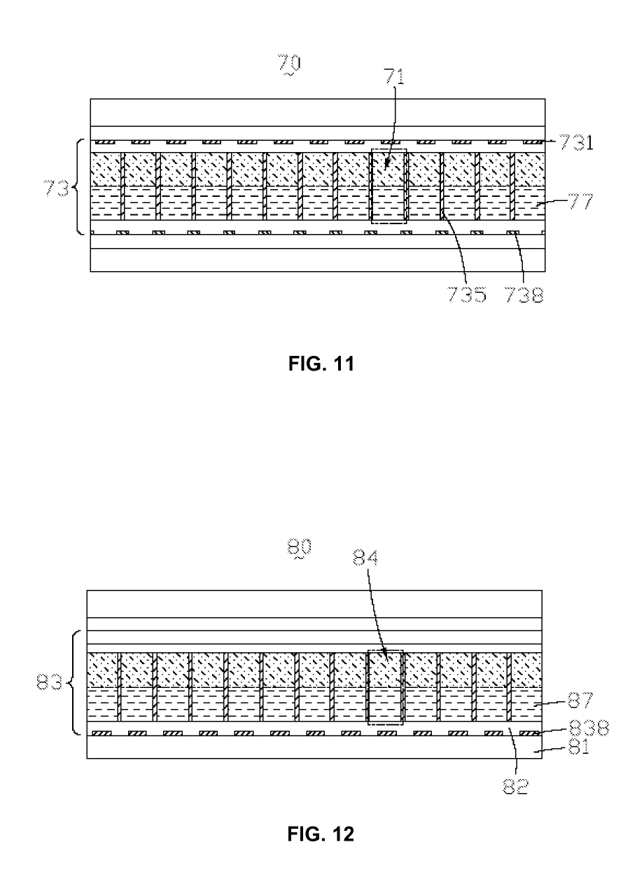

FIG. 11 shows another exemplary optical device 70. Optical device 70 is similar to optical device 50 in both structure and operation. As shown in FIG. 11, optical device 70 may include an electrowetting component 73 and electrowetting component 73 may include a plurality of first electrodes 731, a plurality of fluid chambers 71, a plurality of hydrophobic insulation baffles 735 arranged in parallel with a predetermined interval, a second fluid 77, and a plurality of second electrodes 738. Certain similar components to optical device 50 may be omitted.

A difference between electrowetting component 73 and electrowetting component 53 is that electrowetting component 73 uses a plurality of first electrodes 731 instead of a single plane-shaped first electrode 531. Each of the plurality of electrodes 731 may be arranged at a center of each fluid chamber 71. During operation, two first electrodes 731 and three second electrodes 738 form two electric fields in two neighboring fluid chambers 71. Because plurality of electrodes 731 and plurality of electrodes 738 may be separately controlled, electrowetting component 73 may be able to control different regions of electrowetting component 73 to support 2D display and 3D display at the same time.

FIG. 12 shows another exemplary optical device 80. Optical device 80 is also similar to optical device 50 in both structural and operations. As shown in FIG. 12, optical device 80 may include an electrowetting component 83 and electrowetting component 83 may include a plurality of fluid chambers 84, a second fluid 87, and a plurality of second electrodes 838. Plurality of second electrodes 838 may be placed between second transparent insulation layer 81 and second insulation layer 82. Certain similar components to optical device 50 may be omitted.

A difference between electrowetting component 83 and electrowetting component 53 is that electrowetting component 83 places plurality of second electrodes 838 at the center of fluid chambers 84 (i.e., center of two neighboring hydrophobic insulation baffles). Further, the width of a fluid chamber 84 (i.e., the distance between two neighboring hydrophobic insulation baffles) may be set to the width of one pixel or sub-pixel of LCD panel 43.

During operation, for each fluid chamber 84, a second electrode 838 and a first electrode forms an electric filed within fluid chamber 84 and at the center of fluid chamber 84. Thus, each fluid chamber 84 becomes a liquid lens, and electrowetting component 83 becomes a liquid cylindrical lens grating.

What is claimed is:

1. An optical device for three-dimensional (3D) display, comprising:
a first substrate;
a second substrate arranged opposite to the first substrate; and
an electrowetting component placed between the first substrate and the second substrate, the electrowetting component including:
a first electrode;
a second electrode arranged corresponding to the first electrode;
a first fluid;
a second fluid undissolvable in or unmixable with the first fluid; and
a plurality of fluid chambers arranged between the first electrode and the second electrode and configured to contain the first fluid and the second fluid,
wherein the plurality of fluid chambers form a plurality of liquid cylindrical lenses when at least one voltage difference is generated between the first electrode and the second electrode.

2. The optical device according to claim 1, wherein:
the first electrode is a single plane-shaped electrode;
the second electrode includes a plurality of strip electrodes arranged in parallel at a predetermined interval and corresponding to the plurality of fluid chambers;
two different voltages are applied to two neighboring strip electrodes and each cylindrical lens comprises two neighboring fluid chambers.

3. The optical device according to claim 2, wherein:
each fluid chamber comprises two correspondingly arranged hydrophobic insulation layers and two hydrophobic insulation baffles;
the hydrophobic insulation baffles are arranged perpendicular to the hydrophobic insulation layers; and
the second electrodes are respectively arranged at vertical ends of the hydrophobic insulation baffles.

4. The optical device according to claim 1, wherein:
the first electrode is a single plane-shaped electrode;
the second electrode includes a plurality of strip electrodes arranged in parallel at a predetermined interval and corresponding to the plurality of fluid chambers;
each fluid chamber form one cylindrical lens under the at least one voltage difference between the first electrode and the plurality of strip electrodes.

5. The optical device according to claim 2, wherein:
each fluid chamber comprises two correspondingly arranged hydrophobic insulation layers and two hydrophobic insulation baffles;
the hydrophobic insulation baffles are arranged perpendicular to the hydrophobic insulation layers; and
the first electrode includes a plurality of strip electrodes arranged in parallel at a predetermined interval and respectively corresponding to centers of the plurality of fluid chambers.

6. The optical device according to claim 1, wherein:
the optical device does not change a direction of entering lights when no voltage difference exists between the first electrode and the second electrode.

7. The optical device according to claim 1, wherein:
the optical device is configured to be alternately in a first state where the optical device guides entering lights in a first direction, and a second state where the optical device guides entering lights in a second direction.

8. A three-dimensional (3D) display device, comprising:
a display module configured to display images;
an optical device coupled to the display module to guide lights from the images displayed by the display module; and
a driving module configured to control optical device to switch between a 2D display and a 3D display,
wherein the optical device comprising:
a first substrate;
a second substrate arranged corresponding to the first substrate; and
an electrowetting component placed between the first substrate and the second substrate, the electrowetting component including:
a first electrode;
a second electrode arranged corresponding to the first electrode;
a first fluid;
a second fluid undissolvable in or unmixable with the first fluid; and
a plurality of fluid chambers arranged between the first electrode and the second electrode and configured to contain the first fluid and the second fluid,
wherein the plurality of fluid chambers form a plurality of liquid cylindrical lenses when at least one voltage difference is generated between the first electrode and the second electrode.

9. The 3D display device according to claim 8, wherein:
the first electrode is a single plane-shaped electrode;
the second electrode includes a plurality of strip electrodes arranged in parallel at a predetermined interval and corresponding to the plurality of fluid chambers;
two different voltages are applied to two neighboring strip electrodes and each cylindrical lens comprises two neighboring fluid chambers.

10. The 3D display device according to claim 9, wherein:
each fluid chamber comprises two correspondingly arranged hydrophobic insulation layers and two hydrophobic insulation baffles;
the hydrophobic insulation baffles are arranged perpendicular to the hydrophobic insulation layers; and
the second electrodes are respectively arranged at vertical ends of the hydrophobic insulation baffles.

11. The 3D display device according to claim 8, wherein:
the first electrode is a single plane-shaped electrode;
the second electrode includes a plurality of strip electrodes arranged in parallel at a predetermined interval and corresponding to the plurality of fluid chambers;
each fluid chamber form one cylindrical lens under the at least one voltage difference between the first electrode and the plurality of strip electrodes.

12. The 3D display device according to claim 9, wherein:
each fluid chamber comprises two correspondingly arranged hydrophobic insulation layers and two hydrophobic insulation baffles;
the hydrophobic insulation baffles are arranged perpendicular to the hydrophobic insulation layers; and
the first electrode includes a plurality of strip electrodes arranged in parallel at a predetermined interval and respectively corresponding to centers of the plurality of fluid chambers.

13. The 3D display device according to claim 8, wherein:
the optical device does not change a direction of entering lights when no voltage difference exists between the first electrode and the second electrode.

14. The 3D display device according to claim 8, wherein:
the optical device is configured to be alternately in a first state where the optical device guides entering lights in a first direction to form display, and a second state where the optical device guides entering lights in a second direction to form display.

15. The 3D display device according to claim 14, wherein:
a frequency of a time sequence signal provided to the optical device to control switching between the first state and the second state is the same as a frequency of changing a left image and a right image by the display module.

16. The 3D display device according to claim 14, wherein:
the frequency is 120 Hz.

17. The 3D display device according to claim 8, wherein:
the display module is one of a liquid crystal display, a plasma display panel display, a cathode ray tube display, and an organic light emitting diode (OLED) display.
